(19) United States
(12) Patent Application Publication
(10) Pub. No.: US 2013/0110452 A1
(43) Pub. Date: May 2, 2013

(54) PERMANENT SYSTEM FOR 3D LOCATION OF AN INDIVIDUAL MOVING INSIDE A BUILDING

(71) Applicants: Philippe Le Goff, Epalinges (CH); Catherine Hugel-Le Goff, Epalinges (CH); Raymond Andrieu, Yens (CH)

(72) Inventors: Philippe Le Goff, Epalinges (CH); Catherine Hugel-Le Goff, Epalinges (CH); Raymond Andrieu, Yens (CH)

(73) Assignee: HYGIE-TECH SA, Sion (CH)

(21) Appl. No.: 13/695,462

(22) PCT Filed: Apr. 13, 2011
(86) PCT No.: PCT/IB11/00812

§ 371 Date: Nov. 26, 2012

(30) Foreign Application Priority Data
Apr. 30, 2010 (CH) 00656/10

(51) Int. Cl. G01C 22/00; G06F 15/00

(52) U.S. Cl. CPC G01C 22/006; G06F 15/00
USPC 702/141; 702/150

(57) ABSTRACT

A system for accurately locating and positioning a person moving or standing still inside a hostile or severely damaged environment. For a person walking through any given environment, the location system continuously provides coordinates for positioning the person within the environment relative to the entry point thereof. The location system uses the morphological data of the person and integrates the person's movement in real time by acquiring features of the person's pace as the result of simultaneously combining the angles formed by the ankles, knees and hips of the person when walking, measured by electrogoniometers and interpreted according to a developed calculation method. The location system outdoes other existing solutions for locating a person in a difficult environment, such as, inside an underground building, partially collapsed and filled with opaque smoke, without the risk of faulty measurements, since it does not track by waves or by any vision-based system.

Locating an individual moving around in a given environment, and more particularly in an inside environment, remains an insufficiently satisfied objective despite the recent advances made in wireless modes of communication.

In fact, a person skilled in the art, in this case the response and safety professional, knows that the systems for location by GPS or by GSM are ineffective and inaccurate inside buildings, that the systems integrating the installation of an interior network by radiofrequencies or ultrasounds will be ineffective if the responding official is not equipped with a receiver or if the network is put out of service, that vision systems are neutralized by opaque smoke, and that laser or infrared tracking techniques will be able to be distorted by the change in the interior environment in relation to its prior state (collapse of characteristic features, appearances of heat sources, etc.).

During recent years, a considerable body of works has been published without any solution emerging with a universal character thereof. However, the very great majority of the systems proposed share the common characteristic of being composed of a dual system consisting of a transmitter and a receiver or else a base and a collector. According to this approach, the individual advancing into the environment must be equipped with a device (carried part) communicating with the previously installed system (stationary part) in the controlled space.

Thus, according to this principle, a number of inventions are found among which the following solutions will be cited by way of illustration, without any intention of being exhaustive to the extent that the approach will remain separate from the one of this invention.

The invention described under reference WO2005/103754 is based on a technique for locating a mobile telephone through the wireless telephone network with a precision that can vary greatly depending on the environment concerned.

The invention described under reference WO00/34803 is based on a technique for locating an entity equipped with a camera that is carried while moving in an environment that is equipped with visual references capable of being identified by the camera according to a prior learning mode.

The invention described under reference WO2010/022797 A1 is based on a technique for locating, in an interior environment, an electronic mobile device through a network of radiofrequencies.

The invention described under reference WO2008/143613 is based on a technique for tracking a moving object by a network of cameras previously installed in the environment to be monitored.

The invention described under reference WO2008/036325 is based on a technique for locating by static terminals and a mobile transmitter, preferably of the laser beam type. This invention is mainly intended for individuals having weak visual acuity.

The invention described under reference WO2007/129939 is based on a technique for locating, by a mobile receiver communicating with a network, stationary transmitters according to an RSSI (Radio Signal Strength Intensity) technology.

The invention described under reference WO2009/022265 is based on a technique for changing, by a moving object, optical paths emitted by a network of light sources (visible or not) and collectors previously placed in the environment to be monitored.

To be operational, this solution requires the proper operation of the stationary and carried parts of the locating system. In case of disturbance of the communicating system or of changing of the environment, the whole system can then prove ineffective. Now, the interventions of rescue teams most often take place in environments that are degraded in relation to their normal state, and the reliability of pre-arranged systems can thereby be altered whereas total reliability is required in emergency situations. Furthermore, these systems also exhibit the double drawback of requiring considerable investments to pre-equip the installations using necessary relays or transmitters for locating in any area and to equip all the responders with receivers compatible with the communicating network.

In this context, the invention described in this document offers a system capable of overcoming the drawbacks raised in the prior art by obtaining a solution that is reliable in all circumstances, universal, to the extent that it does not require the interfacing of the response team on a communicating system that is beyond its control, “client system notion,” and inexpensive, considering alternative approaches that impose considerable installation and maintenance expenses.

This invention, designated Locating System, offers to a person skilled in the art a 3D locating solution, in a possibly degraded environment. The Locating System has been designed to be reliable in all circumstances and to be independent of “client” communication systems previously installed at the intervention site.

The invention will now be described in reference to the accompanying figures in which:

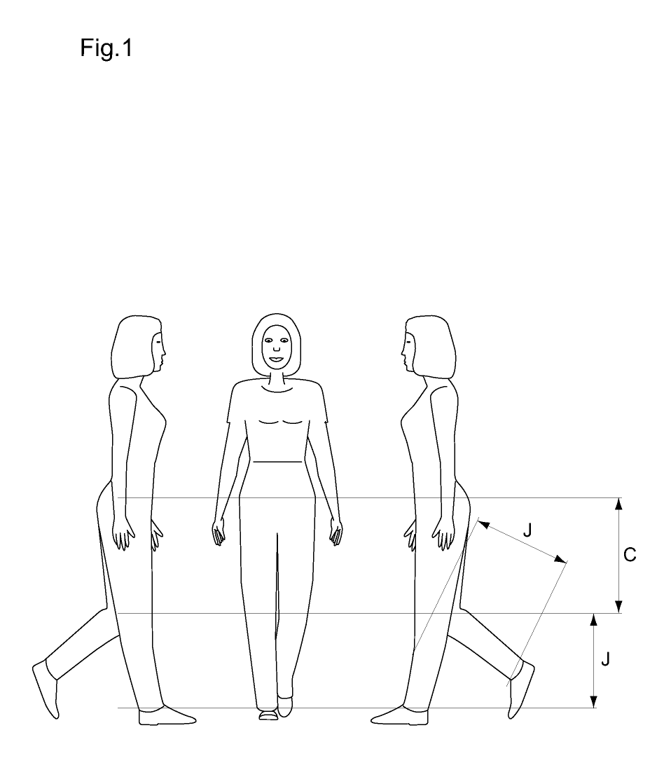

FIG. 1 illustrates the lengths of certain morphological parameters of an individual on a typical mannequin.

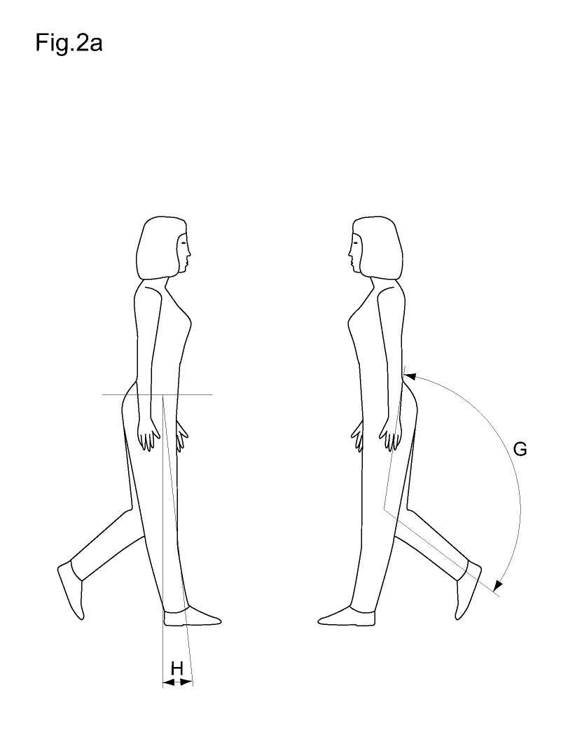

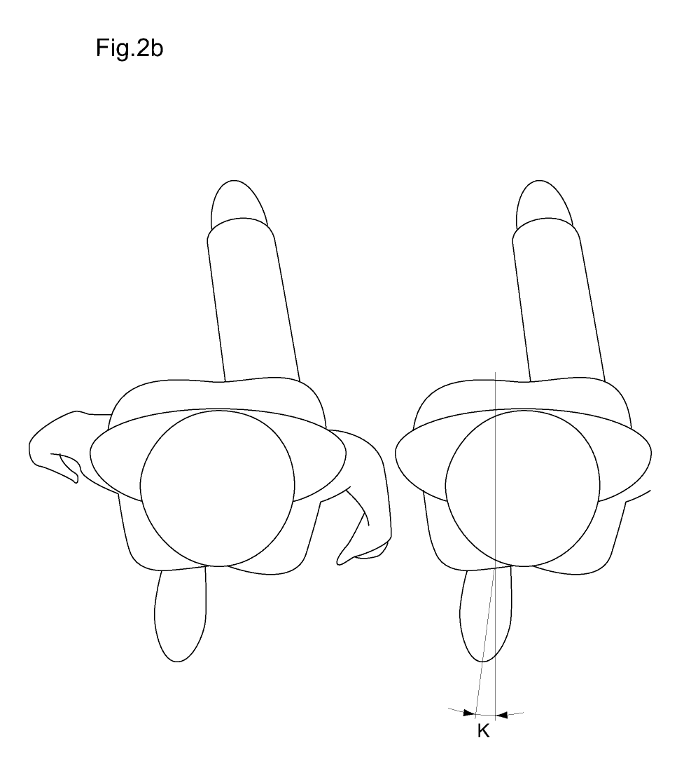

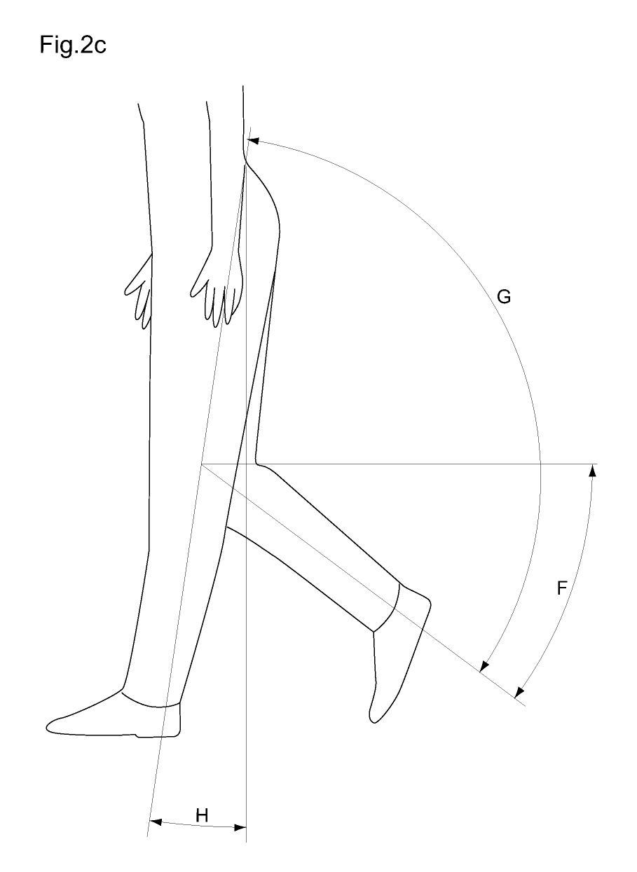

FIGS. 2a, 2b, 2c illustrate the angles formed between certain morphological parameters.

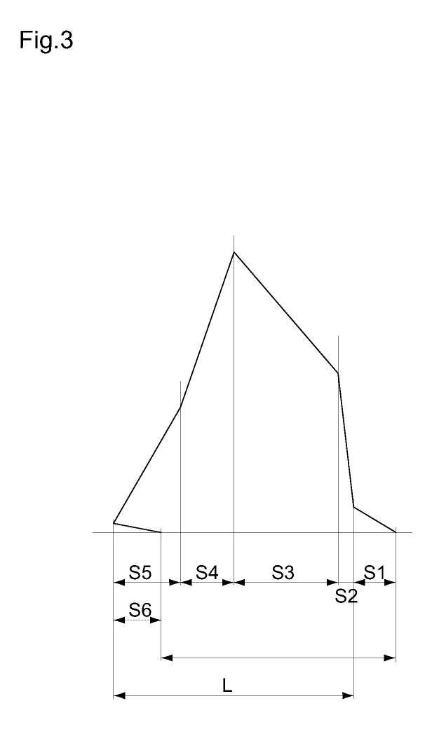

FIG. 3 graphically illustrates the amplitude of a step.

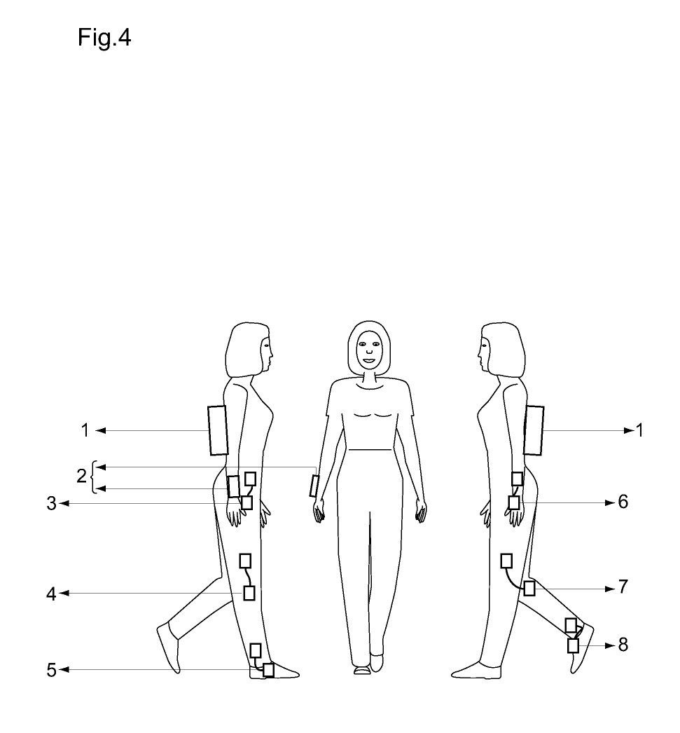

FIG. 4 diagrammatically illustrates the sensors and the control case equipping a mannequin.

For an individual moving about on foot in any environment, the Locating System continuously gives the positioning coordinates of this individual in the environment in relation to his point of entry. The Locating System relies on the morphological data of the individual and incorporates his movement in real time by the acquisition of the characteristics of his pace as the result of the simultaneous combination of the angles, formed by the ankles, the knees and the hips of the advancing individual, measured by electrogoniometers and interpreted according to the calculation method developed by the inventors.

In fact, the position of a moving object can at any moment be defined as being the resultant of the sum of unitary movements associated with a departure point. In the field of mathematics, this assertion results in the Chasles equation which says:

A̅C̅= A̅B̅+ B̅C̅

Thus, for a known origin (A), the position at an instantaneous point (C) is given by the sum of the unitary movements (AB) and (BC). It should be taken into consideration that the position of a point of origin can always be defined, either in a method of overall or universal coordinates (for example, in the “latitude; longitude; altitude” system) or in a method of relative or local coordinates (X; Y; Z system in an orthonormal reference peculiar to the user), and then the only things that remain are to define the notion of unitary movement and to be able to determine the coordinates that each characterize unitary movements of the moving object.

According to the scope of the invention, the moving object consists of an individual moving on foot in any environment. Within this scope, the Chasles equation is applied particularly well when it is defined that the unitary movement consists of a step. In fact, the step can be expressed as being the vector M̅N̅ in which the coordinates of the point (M) are those of the upstream foot during movement and the coordinates of the point (N) are those of the downstream foot. In addition, the coordinates of the point (N) will give the position reached by the moving object at this moment.

Now, in taking into consideration that the point of origin (A) is known, the coordinates of the point (N) will be known if and only if the modulus and the direction of each vector that conveys a unitary movement can be determined according to the equation:

N=( A̅B̅+ B̅C̅+ . . . + M̅N̅)−A

To satisfy the requirement bearing on the knowledge of the modulus and the direction of the vector that renders a unitary movement, the inventors have designed a system based on measurement and calculation to make it possible to connect the step taken by the individual in values that are directly usable by the vector analysis of the movement.

In a first approach, a solution, not accepted by the inventors, would have been able to satisfy this requirement, to combine the use of a system of instruments consisting of a pedometer, a compass and an altimeter. Now, this solution, if it responds to the principles of independence and universality, does not offer the expected reliability because the measurements given by a compass can be distorted by the environment and the use of a pedometer assumes a constant amplitude of step.

The replacement in the preceding solution of the pedometer with a device that measures the distance traveled by contact is not satisfactory either because it has the drawback of possibly hindering the progress of the individual and of remaining affected by the quality of the contact. The replacement in the preceding solution of the pedometer with a device that measures the distance traveled using a wave system (laser, ultrasound, radar, etc.) with the transmitter and the receiver placed on the moving individual is not satisfactory either because it has the drawback of requiring the exact knowledge of the environment and that its configuration be a known one (the open or closed configuration for a door will change the results of the measurement).

The replacement in the preceding solution of the pedometer with a device that measures by inductive effect the distance between the two feet of the individual is not satisfactory to the extent that the technology in its current state does not make it possible to obtain a reliable measurement for spaces between the feet corresponding to those of a normal step (greater than 500 mm).

Furthermore, these alternatives for the replacement of the pedometer do not contribute to a solution to the dependency of the other instruments responsible for giving the sense of the movement.

The inventors have therefore designed an absolutely different system to offer to the user the expected performances of reliability and universality.

The amplitude of the step of an individual can be calculated from the morphological characteristics of the lower limbs of this individual and from the configuration of the articulations that make possible the movement of these limbs.

In a normal individual, the lengths of the segments “C” and “J” (designating respectively the thigh going from the knee up to the hip and the leg going from the ankle up to the knee) constitute personal physical characteristics that are constant over the period of an intervention. FIG. 1 shows the lengths under consideration on a typical mannequin.

These values will be lateralized to correspond to the dimensional characteristics of each of the lower limbs.

Thus, “Cg” and “Jg” will be the values of the lengths measured on the left lower limb whereas “Cd” and “Jd” will be the values of the lengths measured on the right lower limb.

The values “H”, “G” and “K” designate the values obtained respectively by the angles:

“H”: vertical-hip-thigh

“G”: thigh-knee-leg

“K”: dihedral (tibia-ankle-foot vs. tibia-ankle-frontal)

“E”: foot-horizontal

FIGS. 2a and 2b show the angles under consideration on a typical mannequin.

These values will be lateralized to correspond to the positioning of each of the lower limbs.

Thus, “Hg”, “Gg”, “Kg” and “Eg” will be the values of the angles measured on the left lower limb whereas “Hd”, “Gd”, “Kd” and “Ed” will be the values of the angles measured on the right lower limb.

According to this breakdown of the morphology and of the configuration of the moving individual, it can be calculated that the amplitude “L” of the step, shown in FIG. 3, is given by the expression:

L=S2+S3+S4+S5

With:

S2=abs(Jd·cos(Fd))

S3=abs(Cd·cos(Hd))

S4=abs(Cg·cos(Hg))

S5=abs(Jg·cos(Fg)) expressions in which abs(X) designates the absolute value of the value X.

The values of the angles “F” are derived from “G” and “H” by the formula:

F=G−H−90° for values of angles expressed in degrees

FIG. 2c gives the representations of the angles “F”, “G” and “H.”

From this calculation, it is evident that the amplitude “L” of the step corresponds to the modulus of the unitary movement vector according to the vector analysis presented above. The total determination of the movement still requires knowing the direction and the sense in which the movement is performed.

The direction will be determined by the differential between the corrected values of the angles Kd and Kg of the posture values of the individual (these correction values, “Dd” and “Dg,” are specific to an individual and reflect the angle of opening of the feet during walking in a straight line, the case of “walking like a duck”).

Finally, the sense of movement will be that of walking forward.

It should be noted that this method of calculation is as true in a horizontal movement mode as on slopes (by the components of the angles “Ed” and “Eg”) or else on stairs, so that the calculation of the altitude reached is thereby made possible.

This set of considerations closes the theoretical approach of the invention. Putting it into practice requires, first of all, the measurement and storage for a given individual of the characteristic values thereof (“Cd”; “Jd”; “Cg”; “Jg” and “Dd”; “Dg”).

Then, the measurement in real time of the raw values of the characteristic angles of the movement (that is to say, “Hg”; “Gg”; “Kg”; “Hd”; “Gd”; “Kd”) requires a reliable, independent, strong device that can transmit the information and that is not constraining for the individual that must move around.

The inventors have then had the idea of using differential electrogoniometers connected to a multichannel integrator, the integrator itself being connected to a portable programmable interface that interprets the data received to calculate the updated position of the individual in relation to the point of origin thereof. A final pair of sensors of the accelerometer type, placed on each of the legs and preferably on each foot at the level of the heel of the individual in motion, makes it possible to reinitialize the integration process at each step.

FIG. 4 shows a positioning and equipping mode of the sensors and control cases for an individual equipped with the Locating System.

In this Figure, 1 represents the multichannel integrator for the acquiring and processing of the measurements coming from the sensors, 2 is the portable programmable interface, 3 is the differential sensor of the right hip, “4” is the differential sensor of the right knee, “5” is the differential sensor of the right ankle with in addition an accelerometer function, “6” is the differential sensor of the left hip, “7” is the differential sensor of the left knee, “8” is the differential sensor of the left ankle with in addition an accelerometer function.

Depending on the information level available on the portable programmable interface of the individual in motion, the instantaneous positioning of the individual will be able to be overlaid on a 3D mapping of the environment in which he finds himself that can, if needed, include the determination (obtained by CFD modeling) of the level of contamination of the air in which he finds himself in case of intervention in a contaminated environment.

1. System that is carried and independent for three-dimensional locating, in relation to a known origin, for an individual walking in any environment.

2. System according to claim 1 comprising position sensors of the segments of the lower limbs, sensors for impact of the lower limbs, an integrator of the values coming from these sensors, and a user interface giving the position of the individual in his environment.

3. System according to claim 2, in which the position sensors of the segments of the lower limbs consist of differential electrogoniometers or of any other device capable of measuring and transmitting values of angles.

4. System according to claim 2, in which the position sensors of the segments of the lower limbs measure the values of the angles picked up at the level of the hip, the knee and the ankle for the left and right sides of the individual.

5. System according to claim 2, in which the impact sensors of the lower limbs consist of accelerometers or of any other device capable of measuring and transmitting a quick stop.

6. System according to claim 2, in which the impact sensors of the lower limbs are located on each lower limb as close as possible to the foot and preferably at the level of the heel.

7. System according to claim 2, in which the integrator of the values coming from the sensors communicates in real time with said sensors in a wired or wireless mode, but preferably with a connecting wire for each sensor.

8. System according to claim 2, in which the integrator is of the multichannel type with a number of channels at a minimum equal to the number of sensors.

9. System according to claim 2, in which the integrator is independently powered and is carried by the individual.

10. System according to claim 2, in which the values in the integrator are transferred to the user interface and then reinitialized at each pulse coming from an impact sensor.

11. System according to claim 2, in which the user interface is of the small portable computer type making it possible, in real time, to carry out the processing of the information coming from the integrator, to combine it with previously stored data, and to display the results to the individual.

12. System according to claim 2, in which the user interface communicates by receiving packets of data with the integrator in a wired or wireless mode, but preferably with connecting wire.

13. System according to claim 2, in which the user interface is independently powered and is carried by the individual in an easily visible way.

14. System according to claim 2, in which the calculation carried out by the user interface is based only on the data transmitted by the integrator, on the morphological characteristics of the individual, and on the determination of the point of origin.

15. System according to claim 2, in which the morphological characteristics of the individual consist of the lengths of the “thigh” segments (from the hip to the knee) and “leg” segments (from the knee to the ankle) for the limbs on the left side and on the right side; values of the angles of opening of the feet during walking in a straight line.

16. System according to claim 15, in which the calculation of the amplitude of the step is expressed by L=S2+S3+S4+S5 with:
S2=abs(Jd·cos(Fd))
S3=abs(Cd·cos(Hd))
S4=abs(Cg·cos(Hg))
S5=abs(Jg·cos(Fg))
Fg=Gg−Hg−90° for values of angles expressed in degrees
Fd=Gd−Hd−90° for values of angles expressed in degrees
Hg: angle vertical axis-hip-thigh for the left limb
Hd: angle vertical axis-hip-thigh for the right limb
Gg: angle thigh-knee-leg for the left limb
Gd: angle thigh-knee-leg for the right limb
Jg: length of the segment ankle-knee for the left limb
Jd: length of the segment ankle-knee for the right limb
Cg: length of the segment knee-hip for the left limb
Cd: length of the segment knee-hip for the right limb

17. System according to claim 16, in which the calculation of the sense S of the step is expressed by the corrected values of the angles Kd and Kg of the position values of the individual; the correction values of posture “Dd” and “Dg” are specific to an individual and reflect the angle of opening of the feet during walking in a straight line.

18. System according to claim 17, in which the instantaneous position of the individual is calculated in relation to the point of origin as being the sum of the unitary vectors of movement that have for each of them a modulus corresponding to the value L and the S.

19. System according to claim 2, in which the user interface makes it possible to display superimposed the position of the individual in a three-dimensional mapping of the environment in which he moves around.

20. System according to claim 2, in which the user interface makes it possible to display superimposed the position of the individual in a three-dimensional mapping of the environment in which he moves about with display (obtained by CFD modeling) of the level of contamination of the air in the moving-around zone.
